(19) United States
(12) Patent Application Publication
(10) Pub. No.: US 2023/0277885 A1
(43) Pub. Date: Sep. 7, 2023

(54) System and Method for Resonant Acoustic Fire Suppression via Linear Driver or Thermoacoustic Generation

(71) Applicant: Incaendium Initiative Corporation, Richmond, VT (US)

(72) Inventors: Geoffrey Adam Bruder, Rocky River, OH (US); Michael Steven Thomas, Richmond, VT (US)

(21) Appl. No.: 18/118,646

(22) Filed: Mar. 7, 2023

Related U.S. Application Data
(60) Provisional application No. 63/317,497, filed on Mar. 7, 2022.

(51) Int. Cl. A62C 99/00; A62C 3/02; G10K 11/04; G10K 11/26; G10K 9/12

(52) U.S. Cl. CPC A62C 99/0018; A62C 3/0207; G10K 11/04; G10K 11/26; G10K 9/12; A62C 3/0228

(57) ABSTRACT

A novel fire control and extinguishing method intended for a Fire Suppression System. This system can be mounted statically, deployed from a vehicle, or incorporated into a complete unmanned vehicle (autonomous or remotely operated) using an electrical system or thermoacoustic means to generate acoustic waves to accomplish fire control and/or fire suppression. This approach eliminates the need for a vehicle to carry chemical flame retardants/extinguishers, or other traditional fire combating means, resulting in an impactful environmental footprint reduction and a marked specific efficiency improvement. The acoustic wave is generated through thermoacoustic or mechanical means using a linear actuator of magnet-and-coil, piezoelectric, or magnetostrictive construction and operating near mechanical, electrical, and acoustic resonance to reduce system power and mass.

### REFERENCE TO RELATED APPLICATIONS

This application claims priority to the U.S. provisional application No. 63/317,497 filed on Mar. 7, 2022.

### BACKGROUND OF THE INVENTION

Acoustic fire suppression has been commonly known since the 2012 DARPA work was made public, and several attempts have been made to continue this work and find commercial success with a product that exploits this phenomenon. Existing systems utilize off-the-shelf acoustic drivers such as subwoofers, which are limited in power handling and electrical to acoustic conversion efficiency. The present invention takes advantage of high efficiency acoustic generation techniques utilized in the Stirling and Thermoacoustic power generation fields to advance the state of the art of acoustic fire suppression.

Electrical to acoustic conversion in Stirling and Thermoacoustic engines is routinely achieved at over 85% and acoustic to electrical conversion at over 91% has been demonstrated by SunPower on for the Advanced Stirling Radioisotope Generator program at NASA. These systems, however, operate in a high-pressure inert gas environment so need to be modified for the purpose of producing high intensity acoustic waves into an ambient pressure environment. Furthermore, acoustic generation is accomplished in SONAR applications utilizing piezoelectric and magnetostrictive elements. These high efficiency acoustic generation techniques may also be adapted for ambient acoustic generation with the described methods.

### SUMMARY OF THE INVENTION

Described herein is a novel acoustic generation method and system for a Fire Suppression System, which may be mounted statically, deployed from a vehicle, or incorporated into a complete unmanned vehicle (autonomously and/or remotely operated). The application of thermoacoustic systems utilizing (1) a Rijke and/or a Sondhauss configuration for acoustic fire suppression of a vehicle operating within an active widespread fire, (2) a radial core heat spreader within a thermoacoustic fire suppression apparatus, and (3) heat from the wildfire environment or internal electrical source as a heat source for the Rijke/Sondhauss configurations is a novel approach to wildfire management, control, and suppression. The linear driver generation method uses an electrical system to generate acoustic waves to accomplish fire control and/or fire suppression. The unmanned vehicle version of this technology may be ground based, aerial, or aquatic.

An object of this invention is to provide a mechanism through which an acoustic wave will be generated to extinguish a flame and which does not require replenishing and remains in situ. This approach eliminates the need for a vehicle to carry chemical flame retardants/extinguishers, or other traditional fire combating means, resulting in an impactful environmental footprint reduction and a marked specific efficiency improvement. Acoustic wave generation is an agile and tactical tool that enables the fire suppressant agent, i.e., an acoustic wave, to be produced within a fire-fighting vehicle whereas other conventional fire extinguishing technologies simply carry retardant/extinguishing materials that may never find their targets with the efficiency that an acoustic wave would. Furthermore, the operational time, or efficiency/effectiveness, that is realized from a vehicle that self-generates its own fire extinguishing capability/technology is a significant improvement over the prior art. No refilling of fire extinguishing product is necessary with this acoustic wave generation mechanism, and no lost refill time is expended. When conventional firefighting aircraft, other UAV systems, and ground level personnel must vacate the wildfire environment to replenish fuel, retardant, and/or for safety reasons, progress in fire suppression will be lost. Having a System in situ when others must vacate will significantly reduce the loss of fire suppression gains.

Acoustic generation may be completed in several ways. An electrically generated acoustic wave may utilize traditional magnet and coil drivers or be constructed with piezoelectric or magnetostrictive elements. As the system may be operating within a fire environment, the heat of the surrounding fire may be utilized to generate an acoustic wave utilizing thermoacoustic phenomenon. In all cases, the system is designed to operate near mechanical, electrical, and acoustic resonance to reduce power consumption and system mass.

Finally, a system that combines the linear driver and thermoacoustic generation may be utilized. A linear driver, as described above, would generate an acoustic wave which then is amplified in magnitude through thermoacoustic means.

### BRIEF DESCRIPTION OF THE DRAWINGS

FIG. 1 is an Unmanned Aerial Vehicle with resonant acoustic wave fire suppression system;

FIG. 2 is a Thermoacoustic acoustic wave generator in the Rijke Configuration;

FIG. 3 is a Thermoacoustic acoustic wave generator in the Sondhauss Configuration;

FIG. 4 is a wire mesh type thermoacoustic regenerator;

FIG. 5 is a thermoacoustic “stack”;

FIG. 6 is a radial core heat spreader;

FIG. 7 is an Electro-mechanical actuator; and

FIG. 8 is a Piezoelectric or Magnetostrictive acoustic generator.

FIG. 9 is a close up image of a random fiber regenerator.

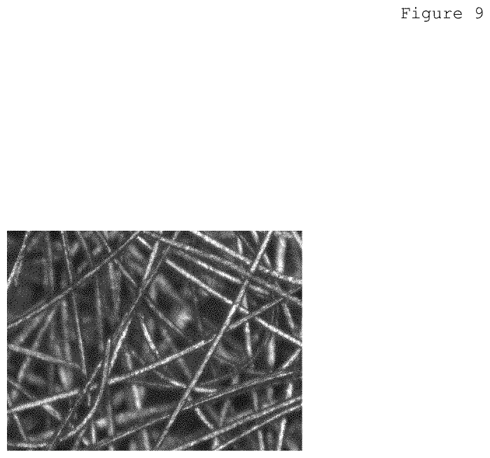

### DETAILED DESCRIPTION OF THE INVENTION

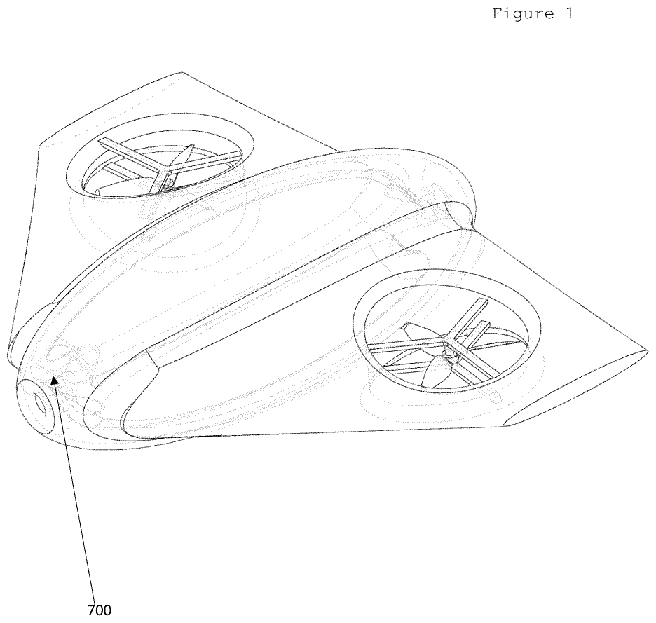

The present inventive thermoacoustic generating method and apparatus provides for a Fire Suppression System, which may be mounted statically, deployed from a vehicle, or incorporated into a complete unmanned vehicle (autonomously and/or manually remotely operated). The unmanned vehicle version of this technology may be ground based, aerial, or aquatic. FIG. 1 depicts an aerial drone that incorporates the inventive thermoacoustic generating apparatus (700) comprising the Rijke Configuration or a Sondhauss Configuration, both of which contain the resonant chamber (310).

Acoustic wave generation is accomplished utilizing one of three mechanisms: 1) thermoacoustic generation, 2) electrically driven acoustic generation 3) a combination of electrically driven and thermoacoustic generation.

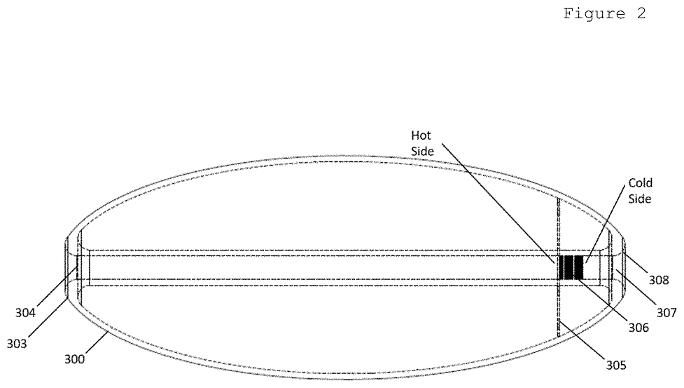

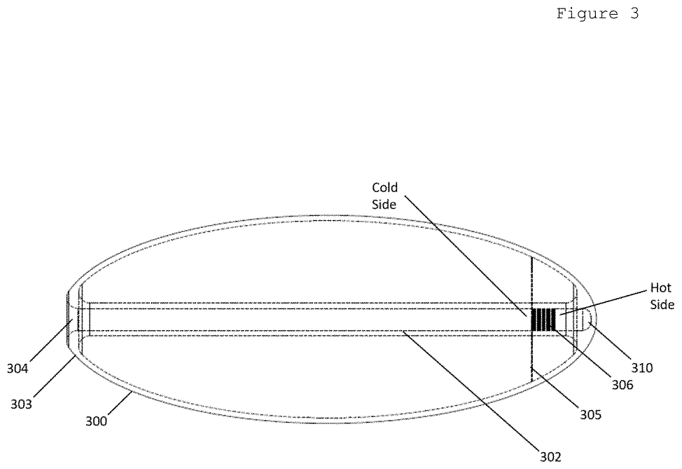

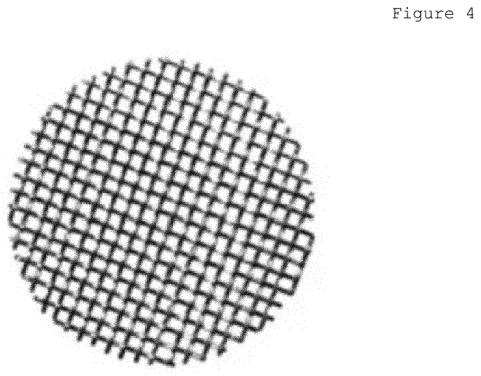

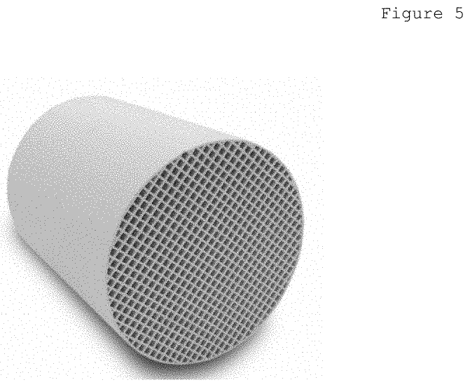

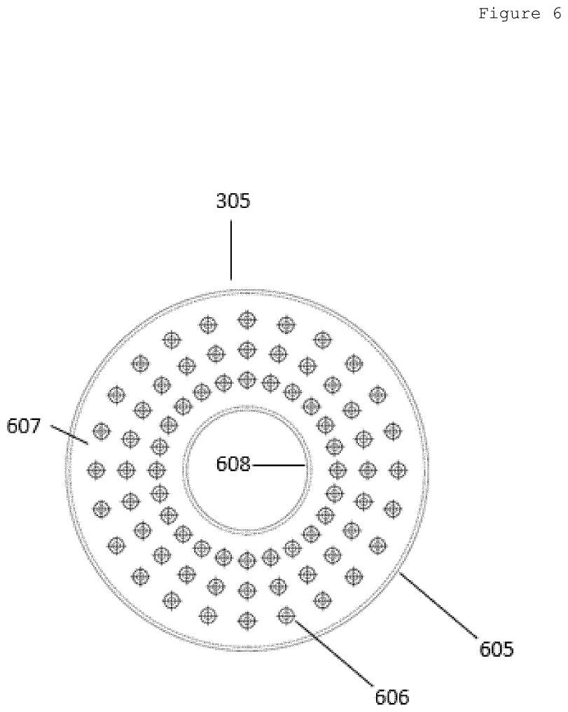

Thermoacoustic generation utilizes either one of two configurations: (1) Rijke configuration as shown in FIG. 2, and (2) the Sondhauss configuration as shown in FIG. 3. These configurations use a mesh Regenerator (306) as shown in FIG. 4 or a stack, an example of which is shown in FIG. 5 for generating the acoustic wave. The stack or regenerator store or remove thermal energy from the oscillating fluid which, using the Stirling cycle, generate and amplify acoustic waves by adding heat as the fluid is expanding and removing heat as the fluid is contracting. A stack is a solid component with pores that allow an operating gas fluid to oscillate while in contact with the solid walls. A mesh Regenerator (306) may be comprised of metallic fibers such as stainless steel, a nickel-based alloy, or an Iron-Chrome-Aluminum alloy. Furthermore, a mesh Regenerator (306) may be comprised of ceramic, Ultra High Temperature Ceramics, or Silicon Carbide (SiC). The fibers of the Regenerator (306) may be a plurality of woven screens or a sintered stack of random fibers. As depicted in FIG. 5, a stack may be fabricated from a low conductivity metal such as a stainless steel, or a low conductivity ceramic material. Both thermoacoustic acoustic wave generation techniques will utilize ambient environment heat to increase the temperature on one side of the Regenerator (306) or Stack (FIG. 5) while utilizing the Coolant Storage Tank (300), shaped within the vehicle to match storage volume with the thermal and weight requirements of the mission, (which may contain nitrogen or other inert gas) to maintain the temperature on the opposing side of the Regenerator near to or below 30° C. Heat strategically conducted, or carried, from the external flame environment is directed to the intended location using the Radial Heat Spreader (305), shown in FIG. 2 and FIG. 6, which can be made of a solid high-temperature capable, high-conductivity material or a heat pipe as used by NASA for Stirling power systems. The Rijke configuration, a roughly cylindrical configuration open to the environment at both ends, as shown in FIG. 2 requires that the hot side of the Regenerator (306) be heated in-parallel with cooled air flowed from the Fluid Inlet Guide (308) toward the Acoustic Exit (304). A standing acoustic wave is formed in the Acoustic Resonator Tube (302) at a frequency dependent on the length of the Acoustic Resonator Tube (302) and the ambient temperature and pressure conditions. In the Sondhauss configuration, a roughly cylindrical configuration open to the environment at one end (304) and closed at the opposing end (310), shown in FIG. 3, the mechanism requires that the Acoustic Cavity (310) at one end to be heated while the fluid volume directly opposite (302) the Regenerator (306) be maintained at near 30° C. A standing acoustic wave is subsequently formed in the Acoustic Resonator Tube (302) at a frequency dependent on the length of the Acoustic Resonator Tube (302). In both the Rijke and Sondhauss configurations, the acoustic wave within the Acoustic Resonator Tube (302) propagates a wave into the ambient environment towards the Acoustic Exit (304), which is directed by the Acoustic Waveguide (302) at the appropriate angle to optimize fire suppression.

The radial heat spreader of FIG. 6. is a multi-directional version of a heat pipe which allows for conductivity up to 10,000 W/mK versus 330 W/mK for solid copper by using phase change. Moreover, heat pipes can work at temperatures much higher than the melting temperature of solid high conductivity materials. The radial heat spreader (305) can be used to remove heat from the cold side of a component or bring heat to the hot side of a component. A heat pipe, and radial heat spreader more specifically, is a hollow metallic shell with a porous wick material inside, and filled with a working fluid that condenses on the cold side and evaporates on the hot side. The shell material (607) for a cold side radial heat spreader will be made from a material such as aluminum or steel alloys, for a hot side radial heat spreader, the shell (607) will be made of a nickel alloy. Dimples (606) protrude through the radial heat spreader to strengthen the shell and allow for thermal contact area inside the working fluid. The wick material is typically a random fiber matrix, like steel wool, and the working fluid is chosen based on the operating temperature which can range from water or ammonia in cold applications to liquid metals sodium or sodium-potassium in hot applications. The inner thermal interface (608) is joined to another component in a manner that allows for good thermal contact, such as a thermal grease or a braze or weld. The outer thermal interface (605) is also joined to another component in a manner that allows for good thermal contact, such as the use of a thermal grease or a braze or weld. For a radial heat spreader that functions on the cold side, the out thermal interface (605) side will condense the working fluid while the inner thermal interface (608) side will evaporate the working fluid. For a radial heat spreader that functions on the hot side, the out thermal interface (605) side will evaporate the working fluid while the inner thermal interface (608) side will condense the working fluid.

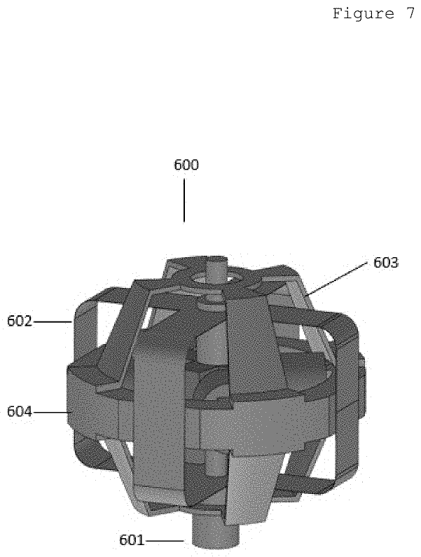

In an acoustic wave generation configuration described as electrically driven acoustic generation, a Command Module, which is a set of electronics such as a Printed Circuit Board (PCB) or combined passive electrical elements with the purpose of controlling the electrical system function, is used to drive an electro-mechanical actuator as shown in FIG. 7. The electro-mechanical actuator may have an active element that is a magnet-and-coil type, Piezoelectric, or Magnetostrictive and is designed to operate near mechanical, electrical, and acoustic resonance to reduce power consumption and system mass. The electro-mechanical actuator as shown of FIG. 7 is comprised of a piston (601), Flexure (Linear Spring)(602), frame (603), and stator (604). In all three configurations the Resonant Volume (311) is designed using the Thiele-Small parameters, or equivalent, including impedance, moving mass, compliance, mechanical resistance, inductance, resistance, and BL coefficient, to assist operational resonance at the desired frequency. The desired operating frequency may change based on application, though infrasound and low frequency (^{˜}10-80 Hz) have been shown the most effective for fire suppression. In the magnet and coil type configuration, a standard voice coil design is used where the Command Module sends an alternating current (AC) voltage at the operating frequency through the coil which causes a linear oscillation. This linear oscillation produces an acoustic wave within the Acoustic Resonator Tube (not shown). Voltage amplitude dictates the acoustic wave amplitude with higher voltage generating a more intense acoustic wave.

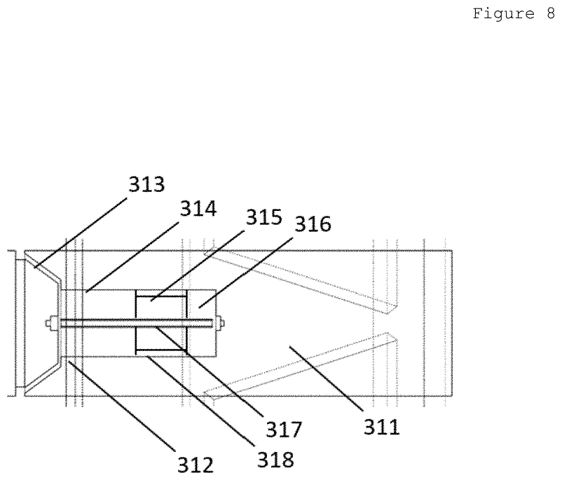

The magnet may be a high temperature magnet, such as Samarium-Cobalt (SmCo) or another high temperature magnetic material to avoid damage in the high-temperature environment. FIG. 8 shows the configuration for the Piezoelectric or Magnetostrictive, referred to as Active Elements, acoustic generator in which the Command Module (not shown) sends an alternating current (AC) voltage at the operating frequency which causes a linear oscillation of the Active Element (315) which can be a Piezoelectric or Magnetostrictive material. In the Piezoelectric case, the Command Module (not shown) sends the AC voltage directly through the Active Element (315). In the Magnetostrictive configuration, the Command Module (not shown) sends the AC voltage through the Coil (318) which generates a magnetic field that causes expansion and contraction of the Magnetostrictive material that, in turn, drives a piston that creates the desired acoustic wave.

In both the Piezoelectric and Magnetosrictive configurations, a Retaining Bolt (317) is connected between the Head Mass (313) and the Tail Mass (316) to ensure that the Active Element (315) remains at or below its un-energized length, the length of the element when sitting at rest prior to being compressed by the retaining bolt, through the operational regime, the length of the Active Element between its compressed length and un-energized length. Furthermore, in both the Piezoelectric and Magnetostrictive configurations, an Oscillatory Matching Layer (312) is utilized to carry the oscillatory energy of the Active Element (315) to the Head Mass (313), while converting the amplitude of oscillation from microns in the Active Element (315) to millimeters in the Head Mass (313), with minimal energy loss. The Oscillatory Matching Layer (312) may be a variable density aerogel or polymer.

The acoustic wave is transmitted into the Acoustic Resonator Tube (302) from the Head Mass (313) and propagates the wave into the ambient environment towards the Acoustic Exit (304), which is directed by the Acoustic Waveguide (302) at the appropriate angle to optimize fire suppression. In the case of both Piezoelectric and Magnetostrictive elements, the typical resonant frequency of an element is in the kHz to MHz range. Piezoelectrical elements may be made of PZT (Lead Zirconate Titanate), or single crystal elements in a single element or stack and wired together. Magnetostrictive elements may be constructed of and material exhibiting a high level of magnetostriction such as Nitinol or Terfenol-D. Electronics within the Command Module utilize “tuning elements”, a capacitive circuit in the case of Piezoelectric and an inductive circuit in the case of the Magnetostrictive element, to reduce the operating frequency down to the desired operating frequency (^{˜}10-80 Hz). As the capacitive or inductive values may be large, synthetic capacitors or inductors may be used to simulate the appropriate shift in Voltage-Current phasing to achieve the desired effect. Similarly, in the case of magnet-and-coil type actuator, a tuning capacitor or synthetic tuning capacitor is used to allow the system to operate near electrical resonance. In all three cases, the electrical, mechanical and gas spring stiffnesses are tuned along with the moving mass to approximate a natural frequency, ω=\sqrt{k/m}, near the desired operating frequency. Furthermore, the Acoustic Exit (304) of the system will utilize mechanical means to vary the outlet angle, diameter and diameter along with the shape of overhang, an intentional impediment to a portion of the acoustic exit which causes vortexing or collimating, intended to cause the exiting wave to vortex or focus the energy into a column. These additional features are operated by the Command Module to vary the angle, intensity, and transmissible distance of the fire suppression by a prescribed algorithm or via remote input from an operator.

The linear driver and thermoacoustic acoustic generation methods may also be combined in order to further amplify the magnitude of the resulting acoustic wave. This configuration will replace the Resonant Cavity of the Sondhauss thermoacoustic configuration with one of the aforementioned electrical generation sources. An acoustic wave will be electrically generated and fed into the cold side of the thermoacoustic regenerator. Heat from the outside environment, or a supplemental electrical heat source will then be added to the hot side of the regenerator. Amplification of the acoustic wave will be roughly equivalent to the absolute temperature ratio.

Another element of the present invention is a control component and methodology which allows for stable operation near electrical resonance to occur, through an electrical control system, a portion of the Command Module. For electrical resonance each of the aforementioned active elements needs the imaginary portion of the complex impedance cancelled out by an appropriate electrical element. In the case of a magnet-and-coil actuator, a tuning capacitor is utilized which may be a static value, such as 1000 μF, or a synthetic capacitor which is an electrical circuit that simulates the same Voltage-Current phase shift in an alternating current circuit as a reactive element such as a capacitor. In the case of a piezoelectric actuator, an inductor or synthetic inductor shall be used. In the case of a magnetostrictive element a capacitor or synthetic capacitor may be used. The control system will monitor the actuator displacement via optical, hall effect, or other means. The motion amplitude versus voltage input will be analyzed in real time with a prescribed algorithm within the Command Module to vary inductance or capacitance along with output frequency to find an optimum, which corresponds to an operating point near resonance. The control system will also limit the voltage such that the actuator does not exceed mechanical limits and cause damage. This control element within the Command Module will also control the mechanism to vary acoustic exit angle and overhang. Further allowing the system to optimize acoustic output based on a prescribed algorithm or remote user input.

A final aspect of this invention involves the use of more than one acoustic source as a means to mitigate system vibration. In this aspect, multiple acoustic sources are oriented such that their vibrational axes are aligned, allowing them to share a compression space and actively negate, or nearly negate, each other's vibrations. In one instance, two drivers will be oriented with the piston faces directed toward one another. This is a common practice in cryo-coolers and Stirling devices. The design can be extended to more than two actuators (magnet-and-coil, piezoelectric, magnetostrictive, or a combination of these), provided that they are aligned and driven in a phase that allows the acoustic outputs to be additive while the transmitted vibration is reduced.

1. A fire control and extinguishing apparatus for fire suppression that can be mounted statically or stationarily, deployed from a vehicle, or incorporated into a complete unmanned vehicle, comprising an acoustic wave system configured to generate and direct resonant acoustic waves, standing or traveling, at a source of fire to accomplish fire control and/or fire suppression.

2. The apparatus of claim 1, wherein the acoustic wave system includes a wave generator configured as a thermoacoustic generator and/or an electrically driven acoustic generator.

3. The apparatus of claim 2, wherein the thermoacoustic generator includes a Regenerator that utilizes ambient environment heat to increase temperature on one side of the Regenerator, and a Coolant Storage Tank to maintain temperature on the opposing side of the Regenerator at near 30° C. or below.

4. The apparatus of claim 2, wherein the thermoacoustic generator includes a stack that utilizes ambient environment heat to increase the temperature on one side of stack, and a Coolant Storage Tank to maintain temperature on the opposing side of the Regenerator at near 30° C. or below.

5. The apparatus of claim 3, wherein the thermoacoustic generation is a Rijke tube configuration.

6. The apparatus of claim 5, further comprising:
a. Fluid inlet guide at one end;
b. An acoustic exit at the opposite end of the fluid inlet guide connected to the Regenerator;
c. An acoustic resonator;
d. An overhang, which is an intentional impediment to a portion of the acoustic exit and configured to cause vortexing or collimating of the acoustic waves exiting from the acoustic exit; and
e. A standing acoustic wave is formed in the Acoustic Resonator Tube at a frequency dependent on the length of the Acoustic Resonator Tube and the ambient temperature and pressure conditions.

7. The apparatus of claim 3, wherein the thermoacoustic generation is a Sondhauss configuration.

8. The apparatus of claim 7, further comprising:
a. An acoustic cavity at one end, connected to
b. A regenerator that is connected to,
c. An acoustic resonator that is connected to
d. An acoustic exit with an overhang, which is an intentional impediment to a portion of the acoustic exit and configured to cause vortexing or collimating of the acoustic waves exiting from the acoustic exit, and
e. A standing acoustic wave is formed in the Acoustic Resonator Tube at a frequency dependent on the length of the Acoustic Resonator Tube and the ambient temperature and pressure conditions.

9. The apparatus of claim 1 further comprising:
a. A Resonant Chamber;
b. An acoustic Generator with an active element or a thermoacoustic element;
c. An Acoustic Generator; and
d. A Waveguide, connected to an Acoustic Exit.

10. The apparatus of claim 5 wherein the Regenerator comprises:
a. metallic fibers made of stainless steel or a nickel-based alloy, or
b. an Iron-Chrome-Aluminum alloy, ceramic, Ultra High Temperature Ceramics, or
c. a stack fabricated from a low conductivity metal such as a stainless steel, or a low conductivity ceramic material, or
d. Silicon Carbide (SiC) that are configured
i. as a plurality of woven screens, or
ii. a sintered stack of random fibers.

11. The apparatus of claim 5, further comprising an Acoustic Cavity that can be heated while the fluid volume directly opposite the Regenerator is maintained at or near 30° C.

12. An apparatus of claim 4 further comprising an Acoustic Exit which is directed by mechanical means at the appropriate angle to optimize fire suppression.

13. An electro-mechanical actuator apparatus of claim 1 further comprising:
a. An active element that is a magnet-and-coil type, or an active element that is a Piezoelectric, or an active element that is Magnetostrictive;
b. A Head Mass, a Tail Mass, and a Retaining Bolt connect between the Head Mass and the Tail mass to ensure the Active Element remains at or below its unenergized length through the operational regime; and
c. A piston, linear spring, frame, and stator.

14. The apparatus of claim 13, comprises means to accomplish fire control and or suppression created through driving an electro-mechanical actuator which has an active element,
a. configured to operate near mechanical resonance,
b. configured to operate near electrical resonance, and
c. configured to operate near acoustic resonance, to reduce power consumption and system mass.

15. The apparatus of claim 13 where the Resonant Volume is designed using the Thiele-Small parameters, or equivalent, to assist operational resonance at the desired frequency in
a. the magnet-and-coil type configuration,
b. the Piezoelectric configuration, or
c. the Magnetostrictive configuration.

16. The apparatus of claim 13 further comprising:
a. A magnetic element constructed of Neodymium, or another high-performance magnetic material;
b. A magnetic element constructed of Samarium-Cobalt, or another high temperature magnetic material; and
c. Piezoelectrical elements that may be made of PZT (Lead Zirconate Titanate), or
d. Piezoelectrical elements that may be made of single crystal elements in:
i. a single element or
ii. a stack and wired together, and
e. Magnetostrictive elements constructed of a material exhibiting giant magnetostriction such as Nitinol or Terfenol-D.

17. The apparatus of claim 13, comprising a control system with a tuning element to simulate the appropriate shift in Voltage-Current phasing to achieve the desired effect, further comprising tuning elements comprising:
a. capacitive circuit in the case of Piezoelectric element;
b. an inductive circuit in the case of the Magnetostrictive element;
c. synthetic capacitors or inductors; and
d. a tuning capacitor or synthetic tuning capacitor for magnet-and-coil type actuator to allow the system to operate near electrical resonance.

18. The apparatus of claim 13, comprising an element to monitor the linear displacement of the actuator to avoid damage and optimize output by:
a. Hall effect,
b. Optical measurement, and
c. ultrasonic measurement.

19. The apparatus of claim 1, comprising more than one acoustic source as a means to mitigate system vibration:
a. Acoustic sources are oriented such that their vibrational axes are aligned,
b. Acoustic sources share a compression space,
c. Acoustic sources are magnet-and-coil, piezoelectric, magnetostrictive or a combination of these, and
d. Acoustic sources are driven in a phase that allows the acoustic outputs to be additive while the transmitted vibration is reduced.

20. The apparatus of claim 1 which utilizes acoustic waves,
a. to accomplish fire control and or suppression,
b. that are created through a linear actuator exciting the ambient air,
c. the acoustic wave is further amplified through thermoacoustic means.
